(19) United States
(12) Patent Application Publication
(10) Pub. No.: US 2024/0219199 A1
(43) Pub. Date: Jul. 4, 2024

(54) NON-SEMANTIC MAP LAYER IN CROWDSOURCED MAPS

(71) Applicant: QUALCOMM Incorporated, San Diego, CA (US)

(72) Inventors: Mandar Narsinh KULKARNI, Bridgewater, NJ (US); Muryong KIM, Madison, NJ (US); Jubin JOSE, Basking Ridge, NJ (US)

(21) Appl. No.: 18/512,780

(22) Filed: Nov. 17, 2023

Related U.S. Application Data
(60) Provisional application No. 63/477,550, filed on Dec. 28, 2022.

(51) Int. Cl. G01C 21/00

(52) U.S. Cl. CPC G01C 21/3848; G01C 21/3841; G01C 21/3878

(57) ABSTRACT

Techniques and systems are provided for vehicle localization. For instance, a process can include obtaining a point corresponding to a target in an environment, the point indicating a location of the target in the environment, and wherein the point is a non-semantic point for use with a non-semantic layer (NSL) of a map, obtaining pose information indicating a heading of a vehicle, generating a map point based on a quantization of the obtained point, and outputting the generated map point to a map server. For another instance, a process can include obtaining a NSL of a map of an environment, the NSL including a map point corresponding to a target in the environment, wherein the point is a non-semantic point; determining, based on a comparison between the pose information and the heading information, that the target is relevant to the vehicle; and transmitting the map point to the vehicle.

### CROSS-REFERENCE TO RELATED APPLICATIONS

This application claims the benefit of U.S. Provisional Application No. 63/477,550, filed Dec. 28, 2022, which is hereby incorporated by reference, in its entirety and for all purposes.

### FIELD

The present disclosure generally relates to mapping for object localization. For example, aspects of the present disclosure are related to systems and techniques for non-semantic map layers in crowdsourced maps.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle. Sensor data, such as images captured from one or more cameras, may be gathered, transformed, and analyzed to detect objects (e.g., targets). Detected objects may be compared to objects indicated on a high-definition (HD) map for localization of the vehicle. Localization may help a vehicle or device determine where on a road the vehicle is travelling. Some cases, such as for merging, exiting, navigating forks in a road, etc., may require more precise location information than available with satellite-based navigation systems. For example, location information, such as those obtained using satellite based navigation system, may be used to determine a road on which the vehicle is travelling. However, such systems may not be able to precisely locate the vehicle on the road. Localization may be used to determine in which portion of a lane the vehicle is in.

To generate information for HD maps, there may be two primary options. The first is to have a dedicated fleet of vehicles to generate HD maps of certain environments. This option tends to have a large overhead, may be difficult to scale, and can result in a long lag time between updates for a given area. Another options for generating HD maps is crowdsourcing the generation of the HD maps where vehicles of users may submit sensor data to generate the HD maps. Crowdsourcing the generation of the HD maps can be more cost effective as there may not be a large fleet of vehicles to maintain and it may be easier to scale and update the HD maps.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for localization is provided. The apparatus includes at least one memory and at least one processor (e.g., configured in circuitry) coupled to the at least one memory. The at least one processor is configured to: obtain a point corresponding to a target in an environment, the point indicating a location of the target in the environment, and wherein the point is a non-semantic point for use with a non-semantic layer of a map; obtain pose information indicating a heading of the apparatus; generate a map point based on a quantization of the obtained point; and output the generated map point to a map server.

As another example, an apparatus for localization is provided. The apparatus includes a at least one memory and at least one processor (e.g., configured in circuitry) coupled to the at least one memory. The at least one processor is configured to: obtain, from a vehicle, pose information for the vehicle; obtain a non-semantic layer of a map of an environment, the non-semantic layer including a map point corresponding to a target in the environment, wherein the point is a non-semantic point; determine, based on a comparison between the pose information and the heading information, that the target is relevant to the vehicle; and transmit the map point to the vehicle.

In another example, a method for localization is provided. The method includes: obtaining a point corresponding to a target in an environment, the point indicating a location of the target in the environment, and wherein the point is a non-semantic point for use with a non-semantic layer of a map; obtaining pose information indicating a heading of a vehicle; generating a map point based on a quantization of the obtained point; and outputting the generated map point to a map server.

As another example, a method for localization is provided. The method includes: obtaining, from a vehicle, pose information for the vehicle; obtaining a non-semantic layer of a map of an environment, the non-semantic layer including a map point corresponding to a target in the environment, wherein the point is a non-semantic point; determining, based on a comparison between the pose information and the heading information, that the target is relevant to the vehicle; and transmitting the map point to the vehicle.

In another example, a non-transitory computer-readable medium for localizing is provided that has stored thereon instructions that, when executed by at least one processor, cause the at least one processor to: obtain a point corresponding to a target in an environment, the point indicating a location of the target in the environment, and wherein the point is a non-semantic point for use with a non-semantic layer of a map; obtain pose information indicating a heading of the apparatus; generate a map point based on a quantization of the obtained point; and output the generated map point to a map server.

As another example, a non-transitory computer-readable medium for localizing is provided that has stored thereon instructions that, when executed by at least one processor, cause the at least one processor to: obtain, from a vehicle, pose information for the vehicle; obtain a non-semantic layer of a map of an environment, the non-semantic layer including a map point corresponding to a target in the environment, wherein the point is a non-semantic point; determine, based on a comparison between the pose information and the heading information, that the target is relevant to the vehicle; and transmit the map point to the vehicle.

In another example, an apparatus for localization is provided. The apparatus includes: means for obtaining a point corresponding to a target in an environment, the point indicating a location of the target in the environment, and wherein the point is a non-semantic point for use with a non-semantic layer of a map; means for obtaining pose information indicating a heading of a vehicle; means for generating a map point based on a quantization of the obtained point; and means for outputting the generated map point to a map server.

In another example, an apparatus for localization is provided. The apparatus includes: means for obtaining, from a vehicle, pose information for the vehicle; means for obtaining a non-semantic layer of a map of an environment, the non-semantic layer including a map point corresponding to a target in the environment, wherein the point is a non-semantic point; means for determining, based on a comparison between the pose information and the heading information, that the target is relevant to the vehicle; and means for transmitting the map point to the vehicle.

In some aspects, the apparatus is, is part of, and/or includes a vehicle or a computing device or component of a vehicle (e.g., an autonomous vehicle), a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIGS. 1A and 1B are block diagrams illustrating a vehicle suitable for implementing various techniques described herein, in accordance with aspects of the present disclosure;

FIG. 1C is a block diagram illustrating components of a vehicle suitable for implementing various techniques described herein, in accordance with aspects of the present disclosure;

FIG. 1D illustrates an example implementation of a system-on-a-chip (SOC), in accordance with some examples;

FIG. 2A is a component block diagram illustrating components of an example vehicle management system, in accordance with aspects of the present disclosure;

FIG. 2B is a component block diagram illustrating components of another example vehicle management system, in accordance with aspects of the present disclosure;

FIG. 3 illustrates an example of localization, in accordance with aspects of the present disclosure;

FIG. 4 illustrates a non-semantic layer (NSL) map tile format, in accordance with aspects of the present disclosure;

FIG. 5 illustrates an example of an enhanced reliability map point of a NSL tile, in accordance with aspects of the present disclosure;

FIG. 6 illustrates a road layout where pose information may be used to enhance NSL layer reliability, in accordance with aspects of the present disclosure;

FIG. 7 illustrates an example of an enhanced reliability map point of a NSL tile, in accordance with aspects of the present disclosure;

FIG. 8 illustrates an example of an enhanced reliability map point of a NSL tile, in accordance with aspects of the present disclosure;

FIG. 9 is a diagram illustrating bins for quantizing observed points in a sensor space, in accordance with aspects of the present disclosure;

FIG. 10 is a flow diagram illustrating an example of a process for crowdsourcing a non-semantic map layer, in accordance with aspects of the present disclosure;

FIG. 11 is a flow diagram illustrating an example of a process for crowdsourcing a non-semantic map layer, in accordance with aspects of the present disclosure;

FIG. 12 illustrates an example computing device architecture of an example computing device which can implement techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Object detection may be used to identify objects. The identified objects may be used to determine where a tracking object is located relative to the identified objects. A tracking object may be understood to refer to any system or device capable of precisely locating itself in an environment and locating other objects in the environment. An example of a tracking object is a vehicle (referred to as an ego vehicle). Examples will be described herein using an ego vehicle s an example of a tracking object. However, other tracking objects can include robotic devices (e.g., an automated vacuum cleaner, an industrial robotic device, etc.), an extended reality (XR) device (e.g., a virtual reality (VR) device, an augmented reality (AR) device, and/or a mixed reality (MR) device).

As noted previously, one or more sensors (e.g., image sensors, such as a camera, range sensors such as radar and/or light detection and ranging (LIDAR) sensors, etc.) of an ego vehicle may be used to obtain information about an environment in which the ego vehicle is located. A processing system of the ego vehicle may be used to process the information for one or more operations, such as localization, route planning, navigation, collision avoidance, among others. For example, in some cases, the sensor data may be obtained from the one or more sensor (e.g., one or more images captured from one or more cameras, depth information captured or determined by one or more radar and/or LIDAR sensors, etc.), transformed, and analyzed to detect objects.

Localization may be used to determine a precise position of an ego vehicle on a map. Localization may be performed based on data input from sensors and a map. For example, location data, such as global navigation satellite system (GNSS) data, global positioning system (GPS) data, or other location data, may be used to identify the location of the ego vehicle within a certain distance (e.g., within a meter, within two meters, etc.). However, this level of accuracy may not be sufficient to precisely place a vehicle in a particular lane of traffic, for example. Localization may be used to more precisely locate the ego vehicle based on a map of the environment. For example, based on a GPS location, the ego vehicle may obtain, such as from a locally or remotely stored map, map information about an area of the environment around the vehicle. In some cases, this map may be an HD map, which may be a highly detailed map which includes multiple layers of information corresponding to information sensors of the vehicle may provide or type of information provided by the layer. For example, an HD map may include a camera-oriented layer which may include images that a camera may capture at a location. The camera-oriented layers may help provide information about features that may be difficult to obtain via other sensors, such as for lane markings. Similarly, the HD map may also include a LIDAR or radar layers which may include, for example, point clouds that a LIDAR or radar sensor may capture at the location. As another example, the HD map may include a non-semantic layer, such as a point cloud, where specific points are not semantically segmented (e.g., labeled) based on what the point represents. The vehicle may compare information provided by sensors of the vehicle to a corresponding HD map layer to precisely locate the vehicle on the map, for example, by triangulating multiple corresponding objects or points.

In some instances, an HD map can include a non-semantic layer (NSL). For instance, NSL data in an HD map can include point clouds generated using one or more sensors, such as radar sensor(s), camera sensor(s), LIDAR sensor(s), any combination thereof, and/or other sensors. In some cases, a repeatability of an NSL point cloud may be dependent on the direction of travel or ego vehicle position from where the point cloud was observed by the vehicle. For example, a vehicle travelling in first direction may observe (e.g., via one or more sensors) a different set of points than a vehicle traveling in a second direction opposite to the first direction. Localization reliability may be increased when the HD map includes points which can be reliably detected over multiple trips. In some cases, techniques for generating a reliable NSL data for crowdsourced maps may be useful.

In some cases, upload data rates for NSL data may be higher than upload data rates for semantic layers. This may be due to a volume of points that may be used for NSL data. In some cases, it may be challenging maintaining NSL data for HD maps due to this high this volume of data. In some cases, techniques for reducing data rates for a NSL layer for crowdsourced maps may be useful.

In some cases, crowdsourced map layers may present privacy issues. For example, NSL data updates effectively provide real-time location information for a vehicle. However, users may be reluctant to use systems which can track their locations. In some cases, accurate pose information is useful for generating a quality NSL for an HD map as the pose information may be used to accurately translate from a frame of reference of the vehicle to a frame of reference for the global HD map. Techniques for accurately obtaining a pose of the vehicle while maintaining user privacy, it may be useful to develop techniques that minimize reliance on sensor data with unique identifiers.

Systems, apparatuses, electronic devices, methods (also referred to as processes), and computer-readable media (collectively referred to herein as “systems and techniques”) are described herein for enhancing non-semantic map layers for maps, such as crowdsourced maps. In some aspects, map point information for a point cloud of the NSL map may be enhanced by adding heading information. The heading information may indicate a direction of travel of a vehicle which observed an object corresponding to the point. The heading (also referred to as heading direction) of a vehicle refers to a direction the vehicle is pointing based on an axis passing through a center of the vehicle through a center of a rear axle of the vehicle and a center of a front axle. As the heading describes the direction the vehicle is pointing, a vehicle travelling in reverse may have a heading direction in a forward direction (e.g., opposite of the movement direction). In some cases, the heading information may be coarse heading information, such as a quadrant of the environment the vehicle is travelling in. In some cases, coarse pose information may also be included. This coarse pose information may include an indication of a road the vehicle is travelling in and/or an indication of a lane on the road in which the vehicle is travelling in. In some cases, a sensor space in which a sensor of the vehicle can detect objects may be divided into a set of bins where each bin includes a coordinate system. By identifying a location of an object in sensor space by identifying a bin and using coordinates within the bin, a number of bits used to represent objects in sensor space may be reduced. In some cases, privacy may also be enhanced by control when and what information, such as identifiers and NSL map data, that may be transmitted to remote servers.

The systems and techniques describe herein can be used to improve the localization accuracy for various applications and systems, including autonomous driving, XR systems, robotics, scene understanding, among others.

Various aspects of the application will be described with respect to the figures.

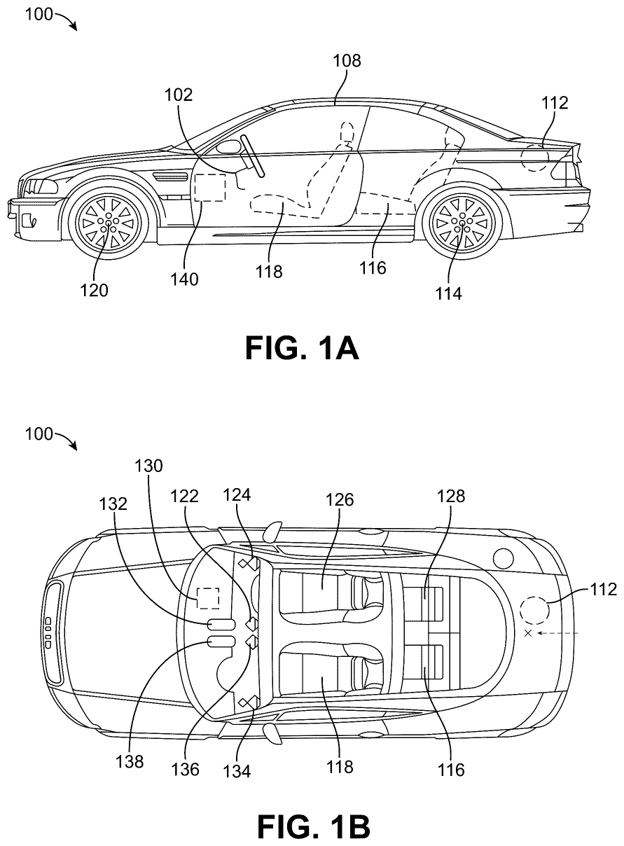

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various aspects using information received from various sensors, particularly the cameras 122, 136, radar 132, and LIDAR 138. In some aspects, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various aspects.

FIG. 1C is a component block diagram illustrating a system 150 of components and support systems suitable for implementing various aspects. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various aspects. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some aspects, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various aspects, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described and may be configured to provide a variety of data to the processor 164 and/or the navigation components 156. For example, the control unit 140 may aggregate and/or process data from the sensors 158 to produce information the navigation components 156 may use for localization. As a more specific example, the control unit 140 may process images from multiple camera sensors to generate a single semantically segmented image for the navigation components 156. As another example, the control unit 140 may generate a fused point clouds from LIDAR and radar data for the navigation components 156.

While the control unit 140 is described as including separate components, in some aspects some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various aspects when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

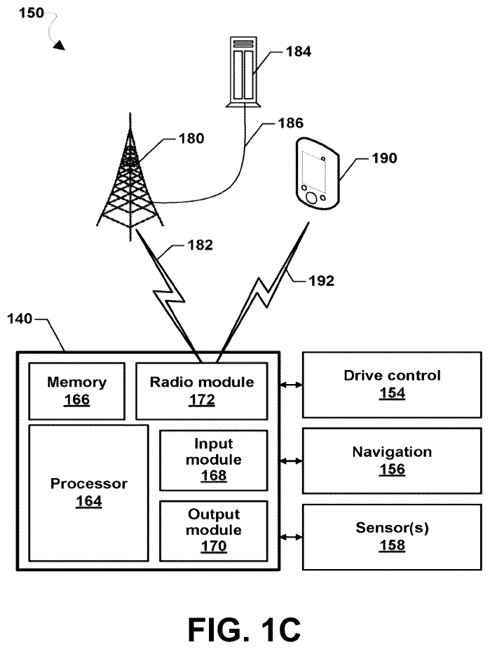

FIG. 2A illustrates an example of vehicle applications, subsystems, computational elements, or units within a vehicle management system 200, which may be utilized within a vehicle, such as vehicle 100 of FIG. 1A. With reference to FIGS. 1A-2A, in some aspects, the various vehicle applications, computational elements, or units within vehicle management system 200 may be implemented within a system of interconnected computing devices (i.e., subsystems), that communicate data and commands to each other. In other aspects, the vehicle management system 200 may be implemented as a plurality of vehicle applications executing within a single computing device, such as separate threads, processes, algorithms, or computational elements. However, the use of the term vehicle applications in describing various aspects are not intended to imply or require that the corresponding functionality is implemented within a single autonomous (or semi-autonomous) vehicle management system computing device, although that is a potential implementation aspect. Rather the use of the term vehicle applications is intended to encompass subsystems with independent processors, computational elements (e.g., threads, algorithms, subroutines, etc.) running in one or more computing devices, and combinations of subsystems and computational elements.

In various aspects, the vehicle applications executing in a vehicle management system 200 may include (but is not limited to) a radar perception vehicle application 202, a camera perception vehicle application 204, a positioning engine vehicle application 206, a map fusion and arbitration vehicle application 208, a route vehicle planning application 210, sensor fusion and road world model (RWM) management vehicle application 212, motion planning and control vehicle application 214, and behavioral planning and prediction vehicle application 216. The vehicle applications 202-216 are merely examples of some vehicle applications in one example configuration of the vehicle management system 200. In other configurations consistent with various aspects, other vehicle applications may be included, such as additional vehicle applications for other perception sensors (e.g., LIDAR perception layer, etc.), additional vehicle applications for planning and/or control, additional vehicle applications for modeling, etc., and/or certain of the vehicle applications 202-216 may be excluded from the vehicle management system 200. Each of the vehicle applications 202-216 may exchange data, computational results and commands.

The vehicle management system 200 may receive and process data from sensors (e.g., radar, LIDAR, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system 200 may output vehicle control commands or signals to the drive by wire (DBW) system/control unit 220, which is a system, subsystem or computing device that interfaces directly with vehicle steering, throttle and brake controls. The configuration of the vehicle management system 200 and DBW system/control unit 220 illustrated in FIG. 2A is merely an example configuration and other configurations of a vehicle management system and other vehicle components may be used in the various aspects. As an example, the configuration of the vehicle management system 200 and DBW system/control unit 220 illustrated in FIG. 2A may be used in a vehicle configured for autonomous or semi-autonomous operation while a different configuration may be used in a non-autonomous vehicle.

The radar perception vehicle application 202 may receive data from one or more detection and ranging sensors, such as radar (e.g., 132) and/or LIDAR (e.g., 138), and process the data to recognize and determine locations of other vehicles and objects within a vicinity of the vehicle 100. The radar perception vehicle application 202 may include use of neural network processing and artificial intelligence methods to recognize objects and vehicles, and pass such information on to the sensor fusion and RWM management vehicle application 212.

The camera perception vehicle application 204 may receive data from one or more cameras, such as cameras (e.g., 122, 136), and process the data to recognize and determine locations of other vehicles and objects within a vicinity of the vehicle 100. The camera perception vehicle application 204 may include use of neural network processing and artificial intelligence methods to recognize objects and vehicles and pass such information on to the sensor fusion and RWM management vehicle application 212.

The positioning engine vehicle application 206 may receive data from various sensors and process the data to determine a position of the vehicle 100. The various sensors may include, but is not limited to, GPS sensor, an IMU, and/or other sensors connected via a CAN bus. The positioning engine vehicle application 206 may also utilize inputs from one or more cameras, such as cameras (e.g., 122, 136) and/or any other available sensor, such as radars, LIDARs, etc.

The map fusion and arbitration vehicle application 208 may access data within a high-definition (HD) map database and receive output received from the positioning engine vehicle application 206 and process the data to further determine the position of the vehicle 100 within the map, such as location within a lane of traffic, position within a street map, etc., using localization. The HD map database may be stored in a memory (e.g., memory 166). For example, the map fusion and arbitration vehicle application 208 may convert latitude and longitude information from GPS into locations within a surface map of roads contained in the HD map database. GPS position fixes include errors, so the map fusion and arbitration vehicle application 208 may function to determine a best guess location of the vehicle 100 within a roadway based upon an arbitration between the GPS coordinates and the HD map data. For example, while GPS coordinates may place the vehicle 100 near the middle of a two-lane road in the HD map, the map fusion and arbitration vehicle application 208 may determine from the direction of travel that the vehicle 100 is most likely aligned with the travel lane consistent with the direction of travel. The map fusion and arbitration vehicle application 208 may pass map-based location information to the sensor fusion and RWM management vehicle application 212.

The route planning vehicle application 210 may utilize the HD map, as well as inputs from an operator or dispatcher to plan a route to be followed by the vehicle 100 to a particular destination. The route planning vehicle application 210 may pass map-based location information to the sensor fusion and RWM management vehicle application 212. However, the use of a prior map by other vehicle applications, such as the sensor fusion and RWM management vehicle application 212, etc., is not required. For example, other stacks may operate and/or control the vehicle based on perceptual data alone without a provided map, constructing lanes, boundaries, and the notion of a local map as perceptual data is received.

The sensor fusion and RWM management vehicle application 212 may receive data and outputs produced by one or more of the radar perception vehicle application 202, camera perception vehicle application 204, map fusion and arbitration vehicle application 208, and route planning vehicle application 210, and use some or all of such inputs to estimate or refine the location and state of the vehicle 100 in relation to the road, other vehicles on the road, and other objects within a vicinity of the vehicle 100. For example, the sensor fusion and RWM management vehicle application 212 may combine imagery data from the camera perception vehicle application 204 with arbitrated map location information from the map fusion and arbitration vehicle application 208 to refine the determined position of the vehicle within a lane of traffic. As another example, the sensor fusion and RWM management vehicle application 212 may combine object recognition and imagery data from the camera perception vehicle application 204 with object detection and ranging data from the radar perception vehicle application 202 to determine and refine the relative position of other vehicles and objects in the vicinity of the vehicle. As another example, the sensor fusion and RWM management vehicle application 212 may receive information from vehicle-to-vehicle (V2V) communications (such as via the CAN bus) regarding other vehicle positions and directions of travel and combine that information with information from the radar perception vehicle application 202 and the camera perception vehicle application 204 to refine the locations and motions of other vehicles. The sensor fusion and RWM management vehicle application 212 may output refined location and state information of the vehicle 100, as well as refined location and state information of other vehicles and objects in the vicinity of the vehicle, to the motion planning and control vehicle application 214 and/or the behavior planning and prediction vehicle application 216.

As a further example, the sensor fusion and RWM management vehicle application 212 may use dynamic traffic control instructions directing the vehicle 100 to change speed, lane, direction of travel, or other navigational element(s), and combine that information with other received information to determine refined location and state information. The sensor fusion and RWM management vehicle application 212 may output the refined location and state information of the vehicle 100, as well as refined location and state information of other vehicles and objects in the vicinity of the vehicle 100, to the motion planning and control vehicle application 214, the behavior planning and prediction vehicle application 216 and/or devices remote from the vehicle 100, such as a data server, other vehicles, etc., via wireless communications, such as through C-V2X connections, other wireless connections, etc.

As a still further example, the sensor fusion and RWM management vehicle application 212 may monitor perception data from various sensors, such as perception data from a radar perception vehicle application 202, camera perception vehicle application 204, other perception vehicle application, etc., and/or data from one or more sensors themselves to analyze conditions in the vehicle sensor data. The sensor fusion and RWM management vehicle application 212 may be configured to detect conditions in the sensor data, such as sensor measurements being at, above, or below a threshold, certain types of sensor measurements occurring, etc., and may output the sensor data as part of the refined location and state information of the vehicle 100 provided to the behavior planning and prediction vehicle application 216 and/or devices remote from the vehicle 100, such as a data server, other vehicles, etc., via wireless communications, such as through C-V2X connections, other wireless connections, etc.

The refined location and state information may include vehicle descriptors associated with the vehicle 100 and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction vehicle application 216 of the autonomous vehicle system 200 may use the refined location and state information of the vehicle 100 and location and state information of other vehicles and objects output from the sensor fusion and RWM management vehicle application 212 to predict future behaviors of other vehicles and/or objects. For example, the behavioral planning and prediction vehicle application 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction vehicle application 216 may output other vehicle and object behavior and location predictions to the motion planning and control vehicle application 214.

Additionally, the behavior planning and prediction vehicle application 216 may use object behavior in combination with location predictions to plan and generate control signals for controlling the motion of the vehicle 100. For example, based on route planning information, refined location in the roadway information, and relative locations and motions of other vehicles, the behavior planning and prediction vehicle application 216 may determine that the vehicle 100 needs to change lanes and accelerate, such as to maintain or achieve minimum spacing from other vehicles, and/or prepare for a turn or exit. As a result, the behavior planning and prediction vehicle application 216 may calculate or otherwise determine a steering angle for the wheels and a change to the throttle setting to be commanded to the motion planning and control vehicle application 214 and DBW system/control unit 220 along with such various parameters necessary to effectuate such a lane change and acceleration. One such parameter may be a computed steering wheel command angle.

The motion planning and control vehicle application 214 may receive data and information outputs from the sensor fusion and RWM management vehicle application 212 and other vehicle and object behavior as well as location predictions from the behavior planning and prediction vehicle application 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control vehicle application 214 may verify and pass various control commands or instructions to the DBW system/control unit 220.

The DBW system/control unit 220 may receive the commands or instructions from the motion planning and control vehicle application 214 and translate such information into mechanical control signals for controlling wheel angle, brake, and throttle of the vehicle 100. For example, DBW system/control unit 220 may respond to the computed steering wheel command angle by sending corresponding control signals to the steering wheel controller.

In various aspects, the vehicle management system 200 may include functionality that performs safety checks or oversight of various commands, planning or other decisions of various vehicle applications that could impact vehicle and occupant safety. Such safety checks or oversight functionality may be implemented within a dedicated vehicle application or distributed among various vehicle applications and included as part of the functionality. In some aspects, a variety of safety parameters may be stored in memory, and the safety checks or oversight functionality may compare a determined value (e.g., relative spacing to a nearby vehicle, distance from the roadway centerline, etc.) to corresponding safety parameter(s) and may issue a warning or command if the safety parameter is or will be violated. For example, a safety or oversight function in the behavior planning and prediction vehicle application 216 (or in a separate vehicle application) may determine the current or future separate distance between another vehicle (as refined by the sensor fusion and RWM management vehicle application 212) and the vehicle 100 (e.g., based on the world model refined by the sensor fusion and RWM management vehicle application 212), compare that separation distance to a safe separation distance parameter stored in memory, and issue instructions to the motion planning and control vehicle application 214 to speed up, slow down or turn if the current or predicted separation distance violates the safe separation distance parameter. As another example, safety or oversight functionality in the motion planning and control vehicle application 214 (or a separate vehicle application) may compare a determined or commanded steering wheel command angle to a safe wheel angle limit or parameter and may issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of vehicle applications, subsystems, computational elements, or units within a vehicle management system 250, which may be utilized within a vehicle 100. With reference to FIGS. 1A-2B, in some aspects, the vehicle applications 202, 204, 206, 208. 210, 212, and 216 of the vehicle management system 200 may be similar to those described with reference to FIG. 2A and the vehicle management system 250 may operate similar to the vehicle management system 200, except that the vehicle management system 250 may pass various data or instructions to a vehicle safety and crash avoidance system 252 rather than the DBW system/control unit 220. For example, the configuration of the vehicle management system 250 and the vehicle safety and crash avoidance system 252 illustrated in FIG. 2B may be used in a non-autonomous vehicle.

In various aspects, the behavioral planning and prediction vehicle application 216 and/or sensor fusion and RWM management vehicle application 212 may output data to the vehicle safety and crash avoidance system 252. For example, the sensor fusion and RWM management vehicle application 212 may output sensor data as part of refined location and state information of the vehicle 100 provided to the vehicle safety and crash avoidance system 252. The vehicle safety and crash avoidance system 252 may use the refined location and state information of the vehicle 100 to make safety determinations relative to the vehicle 100 and/or occupants of the vehicle 100. As another example, the behavioral planning and prediction vehicle application 216 may output behavior models and/or predictions related to the motion of other vehicles to the vehicle safety and crash avoidance system 252. The vehicle safety and crash avoidance system 252 may use the behavior models and/or predictions related to the motion of other vehicles to make safety determinations relative to the vehicle 100 and/or occupants of the vehicle 100.

In various aspects, the vehicle safety and crash avoidance system 252 may include functionality that performs safety checks or oversight of various commands, planning, or other decisions of various vehicle applications, as well as human driver actions, that could impact vehicle and occupant safety. In some aspects, a variety of safety parameters may be stored in memory and the vehicle safety and crash avoidance system 252 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system 252 may determine the current or future separate distance between another vehicle (as refined by the sensor fusion and RWM management vehicle application 212) and the vehicle (e.g., based on the world model refined by the sensor fusion and RWM management vehicle application 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system 252 may compare a human driver's change in steering wheel angle to a safe wheel angle limit or parameter and may issue an override command and/or alarm in response to the steering wheel angle exceeding the safe wheel angle limit.

Systems that usefully (and in some cases autonomously or semi-autonomously) move through the environment, such as autonomous vehicles or semi-autonomous vehicles, need to be able to localize themselves in the environment. For instance, a vehicle may need to be aware of driving surfaces, routes, intersections, exits, places (e.g., gas stations, stores, etc.), etc. based on information to which the vehicle has access (e.g., map information stored locally by the vehicle or accessed from a remote source, such as via a wireless communication with one or more servers).

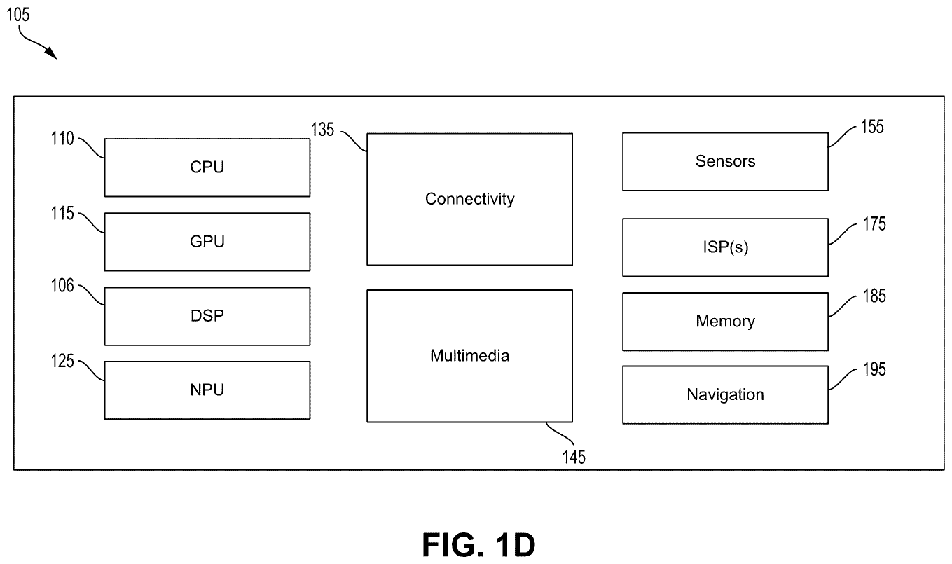

FIG. 3 illustrates an example of localization, in accordance with aspects of the present disclosure. Localization may be performed by, for example, the map fusion and arbitration vehicle application 208 of FIG. 2A and FIG. 2B. In FIG. 3, a vehicle 306 may use localization to accurately place itself in a certain lane on road 302. For example, the vehicle may, based on location information provided by a GNSS receiver system, access an HD map stored locally or from a remote source. In some cases, the HD map may be extremely large and the vehicle 306 may access a portion 300 of the HD map which corresponds to the location of the vehicle 306. The HD map may include information about objects around the vehicle 306, such as for lane markers 308A-308B (collectively, lane markers 308), the road 302, as well as signs 304A-304B (collectively, signs 304) or other objects near the road. In some cases, based on the lane markers 308 visible to sensors of the vehicle 306 and information bout the lane markers 308 in the HD map, the vehicle 306 may be able to accurately localize in which lane the vehicle is. However, the lane markers 308 along do not provide much information on how far down the road 302 the vehicle 306 is (e.g., lane marker 308A looks pretty much like lane marker 308B). Instead, the vehicle 306 may use locations of stationary objects, such as sign 304A and 304B, in the HD maps to determine how far along the road 302 the vehicle 306 is (e.g., between lane marker 308A and 308B).

Generally, localization attempts to identify a position on the HD map by comparing landmarks or features collected from sensor data to corresponding map objects. However, it may not be necessary to provide semantic meaning, (e.g., labels to the map objects, such as lane markers, traffic signs, etc.). Non semantic map layers (NSL) in HD maps may include point clouds generated using, for example, radar, LIDAR, camera images (e.g., feature points), and the like. In some cases, generating and/or maintaining an NSL for an HD map may be based on data gathered by users (e.g., crowd-sourced). Crowd-sourced NSL data may present challenges from a repeatability standpoint, data rate standpoint, and privacy standpoint.

In some cases, such as with a divided freeway with a large center divider between the different directions of travel, a NSL point map of the environment may be independent of a direction of travel and/or lanes from where points of the NSL point map be observed. For example, a vehicle traveling in one direction may observe substantially the same points (e.g., objects) as the vehicle travelling in an opposite direction. Thus, the point cloud, when viewed in a southern or northern direction, may be orthogonal to each other. In cases where the NSL point map of the environment may be independent of the direction of travel, a basic point cloud representation of the NSL map may be used.

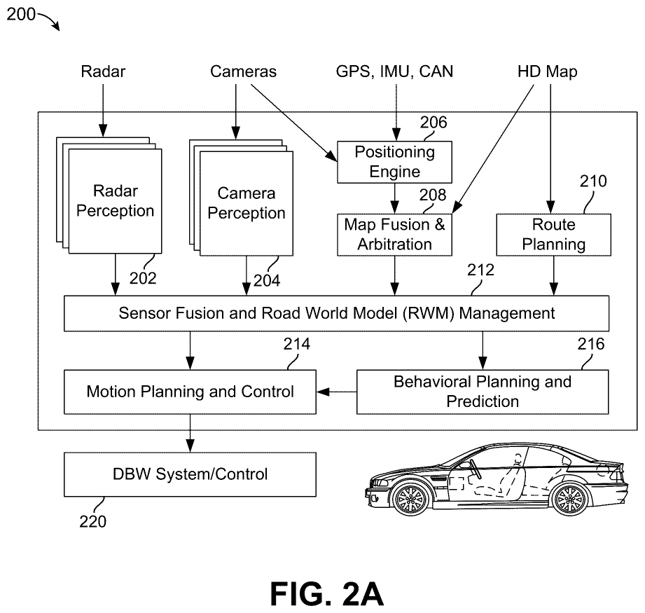

FIG. 4 illustrates a NSL map tile format 400, in accordance with aspects of the present disclosure. In some cases, a map, such as an HD map, may be divided into tiles, where each tile covers a particular portion of the map area. In some cases, tiles may overlap. The tiles may be independent such that tiles may be individually useable and a vehicle may access (e.g., download and/or upload) a tile independently of another tile. The NSL map tile format 400 may include an indication of the map tile 402, a cell size 404 of the tile, a range 406 of the tile, a total number of map points 408, and a list 410 of map points. In some cases, the indication of the map tile 402 may be specified with respect to an cast north up (ENU) origin point. In some cases, the cell size 404 may indicate a spacing of a grid of map points in the map tile 402. The range 406 defines an extent of the tile, and the list 410 is a listing of the map points in the tile. In some cases, the map points in the NSL map may be quantized to help reduce a number of points in a map collected after multiple observations of the environment.

In some cases, map points, of the list 410, may include a location 412 of a map point with respect to the ENU origin. In some cases, map points may also include meta information. In some cases, the meta information may indicate an occupancy probability 414, which may be a confidence value for the map point. Other types of meta information may also be included to help enable more efficient localization.

In some cases, reliability of the NSL point cloud may be increased when the HD map includes points which can be reliably detected over multiple trips. However, in some cases, a vehicle travelling in one direction may see a different set of points than a vehicle traveling in an opposite direction. As an example, an intersection may have different objects on the corners of the intersection, one (or more) curving roads join the intersection, and/or may be approached in a downhill and uphill direction. A vehicle approaching such an intersection in one direction may observe many different points that a vehicle approaching in an opposite direction. Thus, a repeatability of a NSL point cloud may be vary based on a direction of travel or ego vehicle position from where the point cloud was observed by the vehicle.

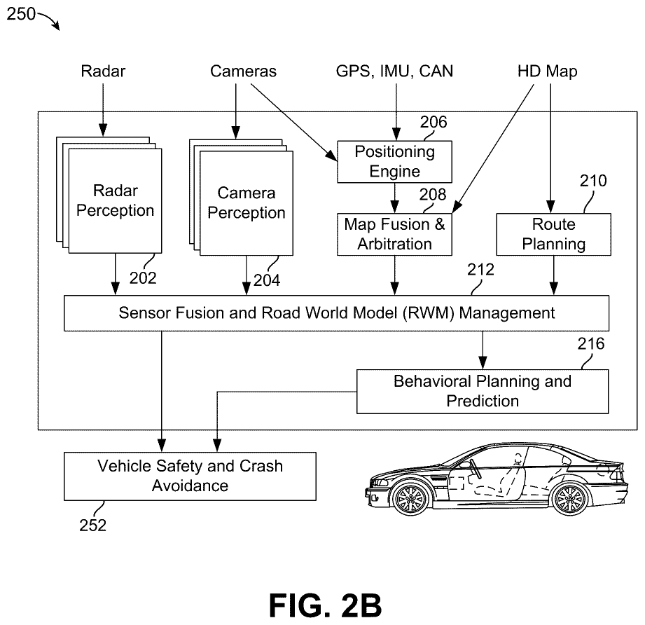

FIG. 5 illustrates an example of an enhanced reliability map point 500 of a NSL tile, in accordance with aspects of the present disclosure. In some cases, to help provide a more reliable NSL layer, heading information 502 may be added to the map points of an NSL layer point cloud. For example, the map point 500 may include the location 412 of a map point and heading information 502, and optionally, meta information such as the occupancy probability 414. In some cases, the heading information 502 may indicate a direction of travel of an ego vehicle when the corresponding map point 500 is observed. In some cases, the heading information 502 may less granular than a heading for the corresponding ego vehicle. For example, the heading of the ego vehicle may be known at a high precision. However, this level of precision may not substantially increase reliability of the NSL layer and using high precision heading information associated with map points may increase a size of the HD map. Instead, the heading information 502 may be a coarse quantization of the heading of the ego vehicle. The coarse quantization may quantize the heading information into a predetermined number of directional ranges (e.g., buckets). For example, the heading of the ego vehicle may be quantized into four directional quadrants (e.g., buckets), such as an indication whether the ego vehicle was headed north/south or east/west, or eight directional quadrants (e.g., buckets), such as north, north east, east, southeast, etc.

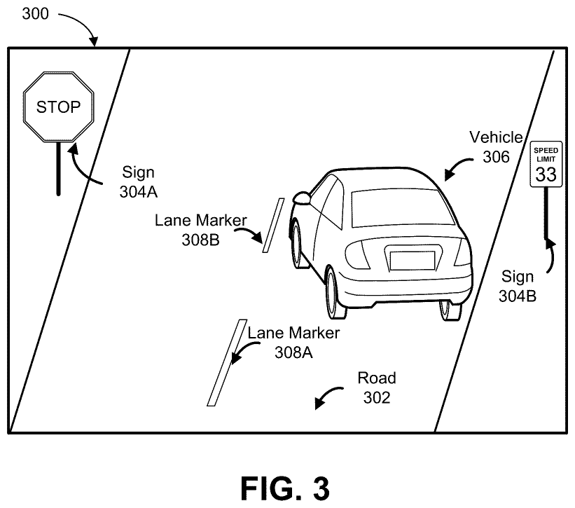

In some cases, to enhance a reliability of a NSL layer, NSL data points may include pose information from an ego vehicle. FIG. 6 illustrates a road layout 600 where pose information may be used to enhance NSL layer reliability, in accordance with aspects of the present disclosure. FIG. 6 includes two parallel roadways 602A and 602B and both roadways 602A and 602B are configured to carry two-way traffic. In some cases, a point cloud observed from the multiple parallel roads may not be same and the point cloud may have an offset or a different pattern due to a potentially different observation angles with respect to the objects in the environment. In some cases, to help provide a more reliable NSL layer, pose information may be added to map points of the NSL layer.

In some cases, some map points may be tagged (e.g., include) with information relating to vehicle sensors. For example, certain sensors on a vehicle may be more likely to observe certain map points. As a more specific example, a front facing camera may see a traffic sign differently while travelling on a route as compared to a rear facing camera. Thus, there may be a different subset of map points that may be observed by the different cameras. The NSL map layer may then include, for some points, an indication of which sensors on a vehicle are more likely to observe the point. In some cases, the NSL map layer may include map points that corresponding to all possible sensor locations around possible vehicles. Based on which sensors are available on a particular vehicle and which direction those sensors are pointed on the particular vehicle, the map server may select a subset of points that are more relevant to the sensors mounted on the vehicle for transmission to the vehicle.

In some cases, some map points may be tagged with information indicating a time of day and/or weather conditions. For example, certain points may not be visible to camera sensors at night or certain points may be more relevant (e.g., snowbanks) or less relevant (e.g., curbs) when it is snowing. In some cases, the NSL map layer may be filtered based on an indication of current conditions experienced by a vehicle. In some cases, the indication of current conditions may be provided by the vehicle or by an external source (e.g., time of day, weather forecast, etc.).

In some cases, if NSL points from multiple vehicles are obtained, for example, at different time of day (daytime, nighttime, etc.)/weather conditions (clear, snowy, rainy, windy, overcast, etc.) then such information may be tagged to the map points, for example, by the map server or based on vehicle data (e.g., vehicle metadata, tags from the vehicle, etc.). In some cases, when NSL map layer data is sent to the vehicle, map points may be filtered based on meta information by matching the conditions to current conditions experienced by the vehicle to help enhance NSL localization performance.

In some cases, a vehicle may upload a subset of detected points. For example, a vehicle may pre-filter points to remove potentially false and/or less reliable points using sensor specific information. For instance, a confidence threshold for each point may be obtained based on the sensor or via post processing. In some cases, the vehicle may upload detected points based on one or more trigger events. For example, uploading detected points may be triggered for a location based on how long it has been since the detections points for the location was previously uploaded. As another example, uploading detected points may be triggered for a location if the NSL map layer for the location is unavailable, or if the NSL map is available but NSL localization fails, indicating map maybe outdated, etc. In some cases, the trigger events may be indicated, for example, by a map server. In some cases, the trigger events may be vehicle specific, or for multiple vehicles, for example, in an area.

After detected points are uploaded, for example to a map server, the uploaded map points may be added to the NSL map layer based on one or more conditions. Examples of the one or more conditions may include whether a timestamp of last map update of a map tile is older than a threshold, if the map server may be replacing a map tile with fresh map points obtained, if there are multiple newly obtained map points for a particular grid cell in quantized NSL map layer which were missing in old map, then the newly obtained map points may be added to NSL layer, and the like.

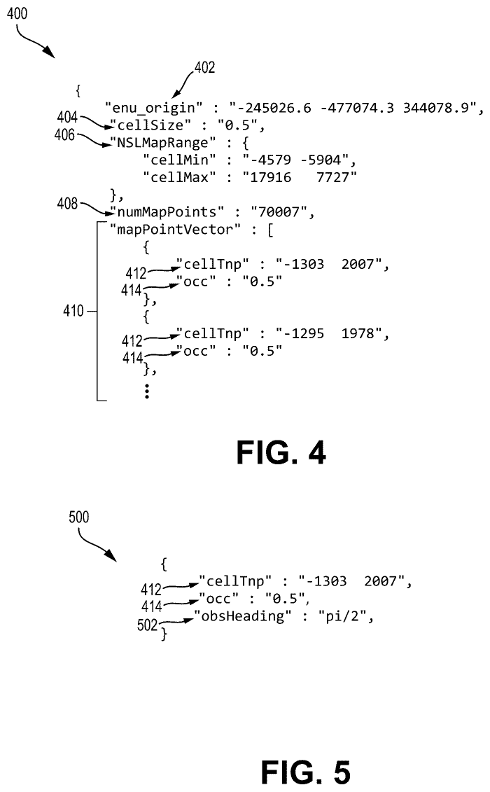

FIG. 7 illustrates an example of an enhanced reliability map point 700 of a NSL tile, in accordance with aspects of the present disclosure. In some cases, it may be beneficial for the NSL map point to include an indication of a pose that may be used to observe a particular map point. In some cases, the pose information may be relatively coarse pose information. For example, an exact pose of an ego vehicle when the ego vehicle observes a point may be too detailed as each observation may be slightly different from another observation. Instead, the coarse pose information may be added to the map point 700 to indicate a path 702 (e.g., road) and/or lane of travel 704 from which the point was observed. In some cases, the path 702 may indicate a road on which the ego vehicle is travelling. In some cases, the lane of travel 704 may be a lane identifier, for example, numbering the lanes from left to right. By providing an indication of a path 702 a vehicle should be on to observe a particular map point 700 may be useful to distinguish certain map points that may not be visible from another nearby path, such as a center reflector of a service road that may not be visible from a parallel neighboring freeway.

In some cases, the road and/or lane from which the ego vehicle observes a point may be determined based on the exact pose of the ego vehicle and semantic HD map layers containing road/lane level information. For example, the ego vehicle may determine the road and/or lane in which it is travelling based on the pose information and generate the coarse pose information. The ego vehicle may then upload the coarse pose information. In other cases, the ego vehicle may upload the exact pose information along with the observed point. In some cases, exact pose information uploaded may be in the world frame. The exact pose information may be processed, for example by a map server, to determine the road and/or lane in which the ego vehicle is travelling based on the exact pose information. In some cases, coarse pose information may be generated based on the determination and the coarse pose information may be saved along with the observed point.

In some cases, not every map point in a NSL may include additional information such as heading information 502, path 702, and/or lane of travel 704. For example, a map point which may be visible no matter which direction the ego vehicle is travelling in may not include the heading information 502, path 702, and/or lane of travel 704. In some cases, two map points with a same location, but different heading information 502, path 702, and/or lane of travel 704 may be considered two different map points.

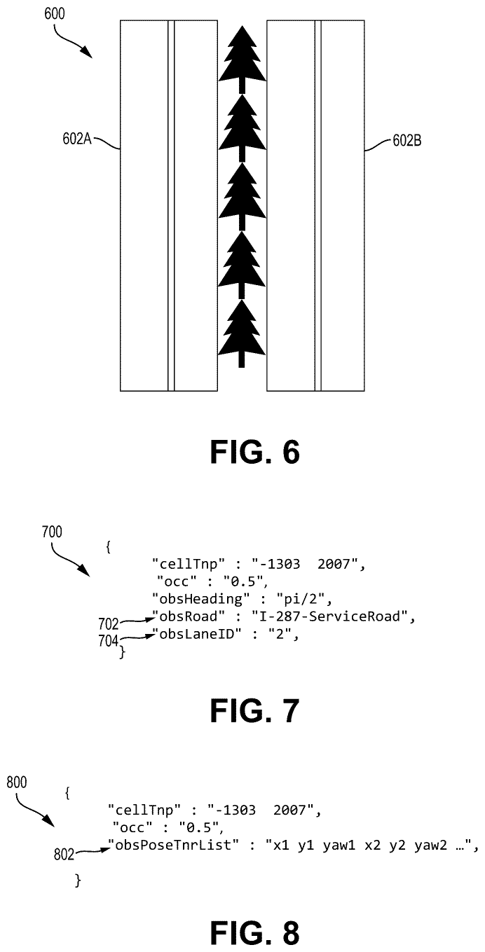

In some cases, the NSL map point may include more detailed information about a pose of the ego vehicle. For example, as shown in FIG. 8, a map point may include a list of poses 802 (2D or 3D) from which the map point may be visible from.

In some cases, an ego vehicle, or a component thereof such as a positioning engine vehicle application 206, may use a NSL in a HD map by obtaining location information for the ego vehicle such as by using GPS data or other similar location data. Based on the location information, the ego vehicle, or a component thereof such as a map fusion and arbitration vehicle application 208, may obtain, such as from a locally or remotely stored map, NSL map tiles relevant for the ego vehicle's location. The ego vehicle, or a component thereof such as a map fusion and arbitration vehicle application 208, may select map points from the obtained map tiles based on estimates of an ego pose to further refining the ego pose estimate using the NSL map layer.

As another example of using a NSL in an HD map, the ego vehicle, or a component thereof such as a positioning engine vehicle application 206, may send an estimated pose, or a proxy for the ego pose, such as heading information 502, path 702, and/or lane of travel 704 to a map server (e.g., a local map server, or remote map server). The map server may then trim the NSL map layer based on the estimated pose and/or proxy for the estimate pose to find map points that align with the estimated pose and/or proxy for the estimate pose. This trimmed NSL map layer may then be sent to the ego vehicle or a component thereof such as a map fusion and arbitration vehicle application 208. Map points for the trimmed NSL map layer may then be used for NSL map aided localization as discussed above.

In some cases, upload data rates for NSL data may be higher than upload data rates for semantic layers. This may be due to a volume of points that may be used for NSL data. In some cases, it may be challenging maintaining NSL data for HD maps due to this high volume of data. For example, for a vehicle travelling on a highway with a typical high-resolution, front facing automotive grade radar (with about 1-5 degree angular resolution in boresight and 1-40 cm range resolution, field of view of +−30 to +−90 degrees), a data rate of about 100 KB/Km is needed. Similarly, the same vehicle travelling in an urban area using the same radar may have a data rate of about 300 KB/Km as urban areas tend to have a higher density of objects as compared to highways. In comparison, a semantic map layer may be typically targeted to have about 10-30 KB/Km data rates in similar applications. In some cases, techniques for hierarchically quantizing observed points in the environment may be used for help generate a reliable NSL layer for crowdsourced HD maps with relatively low upload data rate. In some cases, observed points may be quantized into bins based on the location of the observed points. For example, assuming a sensor for creating a NSL, such as a radar, can detect point targets within +−100 m laterally (e.g., on a Y-axis) and up to 100 m longitudinally (e.g., on an X-axis) with a 10 cm accuracy. Representing a point in this space detectable by the sensor in the X-axis would use 10 bits (e.g., log 2(100/0.1)) would use 11 bits in the Y-axis (e.g., log 2(200/0.1)) for a total of 21 bits per point.

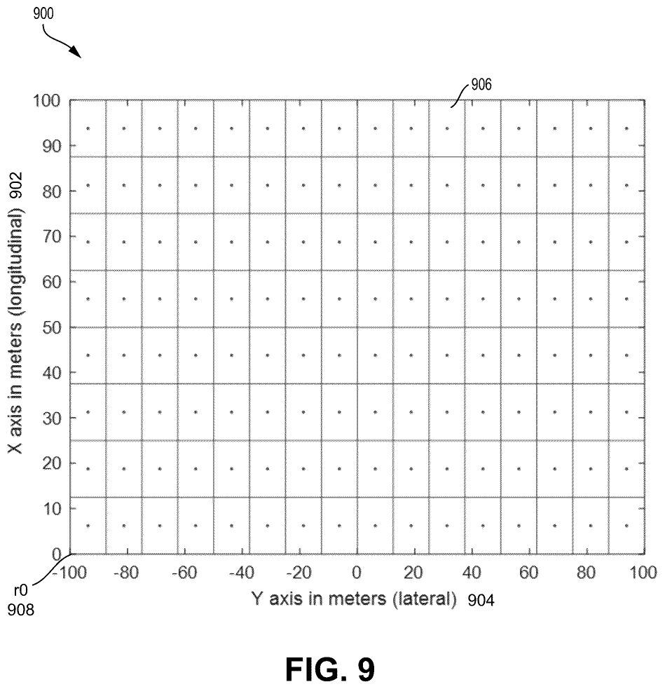

FIG. 9 is a diagram illustrating bins for quantizing observed points in a sensor space, in accordance with aspects of the present disclosure. In some cases, the sensor space 900 in which a sensor can detect an object may be divided into a set of bins (e.g., hierarchal layer) where each bin includes a range of points. Returning to the example sensor above, where the sensor can sense 100 m on an X-axis 902 and 200 m on a Y-axis 904, the sensor range may be divided into equally spaced bins of 12.5 m. In some cases, a size of the bins may be based on sensor specifications, such a size of the sensor space 900 and the accuracy within the sensor space 900 the sensor can detect the object (e.g., 10 cm in this example). The size of the bins may further be based on dividing the range of the X-axis 902 and Y-axis 904 into evenly sized bins 906 which have a size that is close to a 2nth size. In this example, the 100 m range of the X-axis 902 may be divided into eight bins of 12.5 m on the X-axis 902, which is close to 27=128. As the X-axis 902 includes 8 bins, a bin identifier a for the X-axis 902, may be represented by 3 bits. Similarly, the 200 m range of the Y-axis 904 may be divided into 16 bins of 12.5 m on the Y-axis 904. The 16 bins on the Y-axis 904, a bin identifier b for the Y-axis 9024 may then be represented by 4 bits. This allows a bin identifier (a,b) to specifically identify a bin in sensor space 900 with 7 total bits.

Within a specific bin of the bins 906, as the sensor has a 10 cm (or worse) accuracy, any point within the bin may be represented, with respect to an origin point (e.g., 0,0) of a bin, at the most by ceil

$$( log 2 ( \frac{12.5}{0.1} ) ) = 7$$

bits for an X and Y per point. Thus, a unique representation of any point in the sensor space 900 may be represented by 14 bits by quantizing sensor space into bins from 21 bits without quantization. In some cases, additional hierarchal layers (e.g., additional quantization into bins) if needed. A data structure for encoding the quantized sensor space may be used, such as:

struct RadarPacket{
RadarBins[N] radarBin;
}
struct RadarBin{
RadarPoints[M] radarPoints;
Uint3 XBinIndex;
Uint4 YBinIndex;
}
struct RadarPoint{
uint7[2] Trf_quantized;
}

In some cases, additional data rate savings may be obtained by batching. For example, an environment may be scanned by a sensor a number of times per second to generate a frame of points in the sensor space (e.g., point cloud). In some cases, multiple frames of the point cloud may be combined together into a single point cloud. Additionally, intermittent points, that is points that appear in less than a threshold number of frames to be batched together, may be filtered out. For example, for any single frame, there may not be a way to determine whether any point in the single frame represents a real object or if the point represents noise from the sensor. However, by combining multiple frames together, it becomes substantially less likely that noise in the sensor will cause a specific point to be repeated. Additional filtering may also be applied, such as to remove single points without any neighboring points or points which do no move or otherwise change with respect to movement of the vehicle as such points are unlikely to be representative of the environment and may instead be another issue, such as dirt on the sensor.

The batched frame may be transmitted by the vehicle to the map server. Thus, the number of batched frames sent to the map server may be substantially lower than the frame rate of the sensor. In some cases, to help further reduce the data rate, only points within (or above) a certain threshold distance in a frame may be sent to the map server. For example, data points of a frame (either batched or before batching) may be filtered based on a distance threshold to remove data points having a distance greater than (or less than) the distance threshold.

In some cases, crowdsourced map layers may present privacy issues. One challenge in crowdsourced map generation involves accurately combining sensor data from a variety of vehicles and/or sensor types (e.g., different models of cameras, radars, LIDARs, etc.) to generate HD map layers. In some cases, a trace or vehicle identifier (henceforth called trace ID) along with vehicle information may be used to help enable greater accuracy of graphs (e.g., nodes as vehicle locations and edges as relative position changes) that may be used for map generation. The trace ID may also be used to determine what type and quality of sensors being used, as well as for determining pose correction. Additionally, a map server may also use trace IDs to learn that data coming from certain trace ID is more erroneous than rest and accordingly down weigh data from that vehicle from map generation. However, such identifiers may effectively provide a record of and/or real-time location information for a vehicle. In some cases, users may be reluctant to use systems which can track their locations.

In some cases, privacy for crowdsourced HD map data, such as NSL data may be increased by modifying data collection at a beginning and end of a trip. For example, the vehicle may be configured not to transmit any HD map data within a certain distance of beginning a trip. Similarly, the vehicle may not transmit any HD map data with a certain distance of ending the trip. Alternatively, the vehicle may transmit HD map data, but does not transit vehicle identifiers (e.g., trace IDs) with the certain distance of beginning and/or ending the trip. In cases where the vehicle does not know the destination (e.g., when a vehicle is manually driven or where a destination is changed, the vehicle may be configured to send chunks or bursts of data every L meters and/or N seconds/minutes to the map server. In some cases, there may also be a delay time T applied to the bursts. Additionally, the delay time T may be randomized. This helps allow a server to be unable to know an current location of the vehicle when the data is received. In some cases, as a speed of a vehicle approaches 0 over a certain amount of time, trace identifiers may be omitted from the data chunks. Otherwise, the trace identifier may be included in the data sent to the map server.

In some cases, privacy for crowdsourced HD map data, such as NSL data may be increased by geofencing certain locations and within such locations, no HD map data may be transmitted to the map server, and/or no trace identifier is sent with the HD map data. In some cases, HD data received by the map server may not be made available for map generation to a certain amount of time, or until the vehicle has moved to another location. In some cases, the vehicle may randomly not send HD map data, or trace identifiers for areas along the route. In some cases, the vehicle may convert, based on the pose of the vehicle, map points detected with reference to the vehicle frame to map points in a global frame of the NSL map and upload such converted map points to the map server. In such cases, pose information for the vehicle may not be provided to the map server

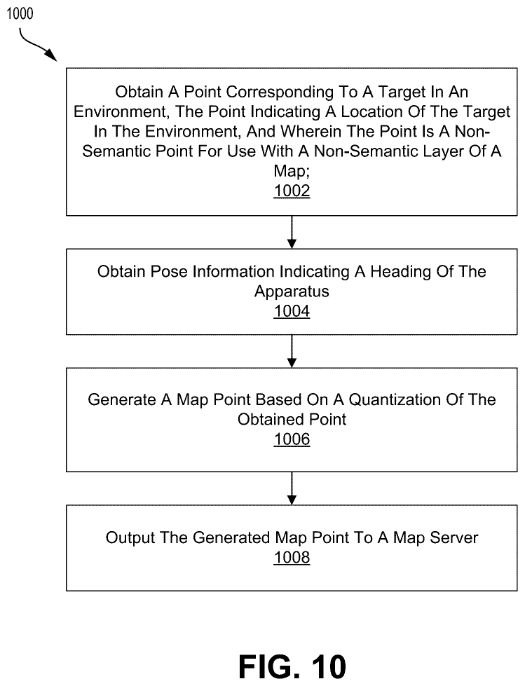

FIG. 10 is a flow diagram illustrating a process for crowdsourcing a non-semantic map layer, in accordance with aspects of the present disclosure. The process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors.

At block 1002, the computing device (or component thereof) may obtain a point corresponding to a target in an environment, the point indicating a location of the target in the environment. In some cases, the point is a non-semantic point for use with a non-semantic layer of a map. In some cases, the point may be a generated by a sensor of the apparatus.

At block 1004, the computing device (or component thereof) may obtain pose information indicating a heading of the apparatus. In some cases, heading information indicated in the pose information is quantized into four directional quadrants. In some cases, these quadrants may be compass directions. In some cases, the computing device (or component thereof) may obtain an indication of a road on which the apparatus is located. In some cases, the map point may include the indication of the road on which the apparatus is located. In some cases, the computing device (or component thereof) may obtain an indication of a lane of the road on which the apparatus is located. In some cases, the map point includes the indication of the lane of the road on which the apparatus is located.

At block 1006, the computing device (or component thereof) may generate a map point based on a quantization of the obtained point. In some cases, the map point includes the location of the target and the pose information. In some cases, the computing device (or component thereof) may determine a bin of a sensor space where the point is located. In some cases, the bin is a portion of the sensor space (e.g., space in which a sensor may detect a target). In some cases, In some cases, the computing device (or component thereof) may determine a bin location within the bin where the point is located. In some cases, the computing device (or component thereof) may encode the location of the target in the map point based on the determined bin and determined bin location. In some cases, the computing device (or component thereof) may output the generated map point based on a location of the apparatus.

At block 1008, the computing device (or component thereof) may output the generated map point to a map server. In some cases, the map server comprises a remote server. In some cases, the map server may be local to the apparatus. In some cases, the computing device (or component thereof), to output the generated map point, the computing device may determine that the apparatus is not within a threshold amount of time of a beginning or end of a trip. In some cases, the computing device (or component thereof) may output the generated map point based on the determination that the apparatus is not within the threshold amount of time of the beginning or the end of the trip. In some cases, the apparatus is associated with a trace identifier. In some cases, the computing device (or component thereof) may determine that the apparatus is not within a threshold amount of time of a beginning or end of a trip. In some cases, the computing device (or component thereof) may output the trace identifier along with the generated map point based on the determination that the apparatus is not within the threshold amount of time of the beginning or the end of the trip. In some cases, the computing device (or component thereof), to output the generated map point, the computing device may determine that the apparatus is not within a threshold distance of a beginning or end of a trip. In some cases, the computing device (or component thereof) may output the generated map point based on the determination that the apparatus is not within the threshold distance of the beginning or the end of the trip. In some cases, the computing device (or component thereof) may output the generated map point based on a speed of the apparatus.

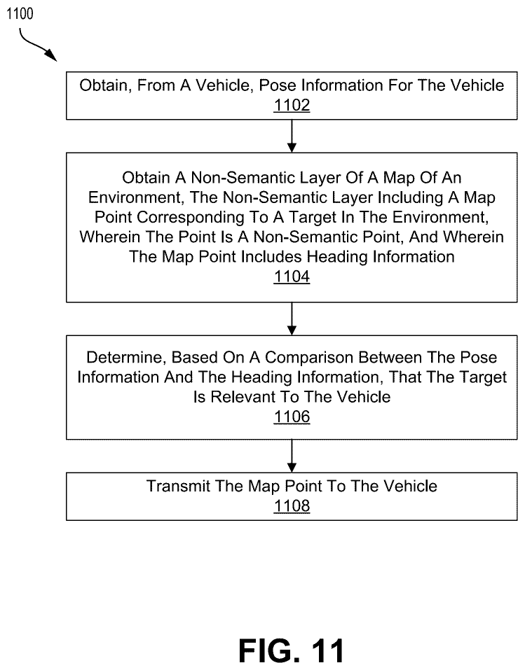

FIG. 11 is a flow diagram illustrating a process for crowdsourcing a non-semantic map layer, in accordance with aspects of the present disclosure. The process 1100 may be performed by a computing device (or apparatus) or a component (e.g., a chipset, codec, etc.) of the computing device. The computing device may be a mobile device (e.g., a mobile phone), a network-connected wearable such as a map server, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors.

At block 1002, the computing device (or component thereof) may obtain, from a vehicle, pose information for the vehicle. In some cases, the computing device (or component thereof) may receive a generated map point from the vehicle. In some cases, the computing device (or component thereof) may determine a threshold amount of time has passed since receiving the generated map point. In some cases, the computing device (or component thereof) may process the received generated map point to add the generated map point to the map of the environment.

At block 1004, the computing device (or component thereof) may obtain a non-semantic layer of a map of an environment, the non-semantic layer including a map point corresponding to a target in the environment. In some cases, the map point includes quantized heading information. In some cases, the point is a non-semantic point. In some cases, the heading information is quantized into a predetermined number of direction ranges. In some examples, the predetermined number of direction ranges comprises four directional quadrants. In some cases, these quadrants may be compass directions. In some cases, the heading information indicates a heading in which the target is observable. In some cases, the map point includes an indication of a road in which the target is observable. In some cases, the computing device (or component thereof) may obtain an indication of a road on which the vehicle is located. In some cases, the computing device (or component thereof) may determine that the target is relevant to the vehicle further based on a comparison between the indication of the road in which the target is observable and the indication of the road on which the vehicle is located. In some cases, the map point includes an indication of a lane on the road in which target is observable. In some cases, the computing device (or component thereof) may obtain an indication of the lane on the road in which the vehicle is located. In some cases, the computing device (or component thereof) may determine that the target is relevant to the vehicle further based on a comparison between the indication of a lane on the road in which target is observable and the lane on the road in which the vehicle is located in. In some cases, the computing device (or component thereof), to obtain the indication of the road on which the vehicle is located, the computing device may determine the road on which the vehicle is located based on the pose information.

At block 1006, the computing device (or component thereof) may determine, based on a comparison between the pose information and the heading information, that the target is relevant to the vehicle. At block 1008, the computing device (or component thereof) may transmit the map point to the vehicle.

In some examples, the processes described herein (e.g., process 1000 and/or other process described herein) may be performed by the vehicle 100 of FIG. 1A.

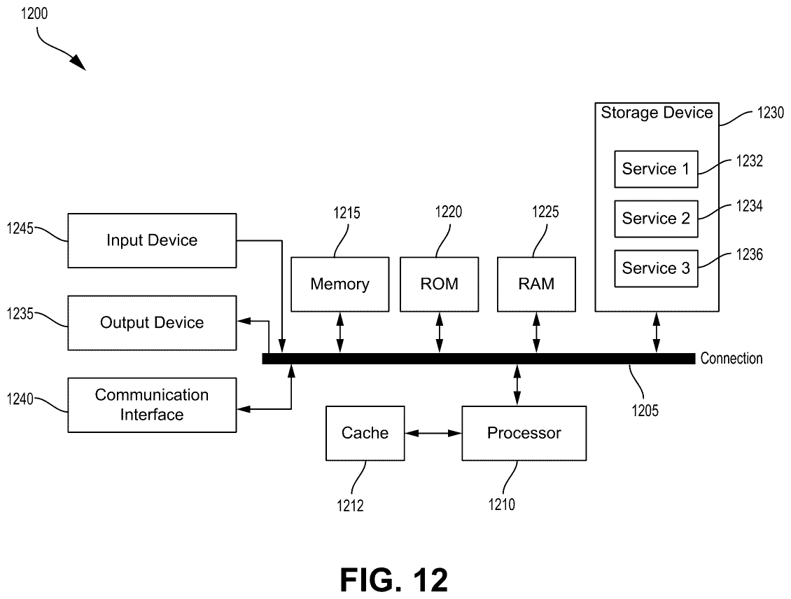

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some embodiments, computing system 1200 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically crasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some embodiments, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X. Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for localization, comprising: a memory comprising instructions; and a processor coupled to the memory and configured to: obtain a point corresponding to a target in an environment, the point indicating a location of the target in the environment, and wherein the point is a non-semantic point for use with a non-semantic layer of a map; obtain pose information indicating a heading of the apparatus; generate a map point based on a quantization of the obtained point; and output the generated map point to a map server.
Aspect 2. The apparatus of Aspect 1, wherein the map point includes the location of the target and the pose information.
Aspect 3. The apparatus of any one of Aspects 1 to 2, wherein the map server comprises a remote server.
Aspect 4. The apparatus of any one of Aspects 1 to 3, wherein heading information indicated in the pose information is quantized into a predetermined number of directional ranges.
Aspect 5. The apparatus of any one of Aspects 1 to 4, wherein the processor is further configured to obtain an indication of a road on which the apparatus is located, and wherein the map point includes the indication of the road on which the apparatus is located.
Aspect 6. The apparatus of Aspect 5, wherein the processor is further configured to obtain an indication of a lane of the road on which the apparatus is located, and wherein the map point includes the indication of the lane of the road on which the apparatus is located.
Aspect 7. The apparatus of any one of Aspects 1 to 6, wherein the processor is further configured to: determine a bin of a sensor space where the point is located, wherein the bin is a portion of the sensor space; determine a bin location within the bin where the point is located; and encode the location of the target in the map point based on the determined bin and determined bin location.
Aspect 8. The apparatus of any one of Aspects 1 to 7, wherein the processor is further configured to output the generated map point based on a location of the apparatus.
Aspect 9. The apparatus of Aspect 8, wherein, to output the generated map point, the processor is configured to: determine that the apparatus is not within a threshold amount of time of a beginning or end of a trip; and output the generated map point based on the determination that the apparatus is not within the threshold amount of time of the beginning or the end of the trip.
Aspect 10. The apparatus of Aspect 8, wherein the apparatus is associated with a trace identifier, and wherein the processor is further configured to: determine that the apparatus is not within a threshold amount of time of a beginning or end of a trip; and output the trace identifier along with the generated map point based on the determination that the apparatus is not within the threshold amount of time of the beginning or the end of the trip.
Aspect 11. The apparatus of Aspect 8, wherein, to output the generated map point, the processor is configured to: determine that the apparatus is not within a threshold distance of a beginning or end of a trip; and output the generated map point based on the determination that the apparatus is not within the threshold distance of the beginning or the end of the trip.
Aspect 12. The apparatus of any one of Aspects 1 to 11, wherein the processor is further configured to output the generated map point based on a speed of the apparatus.
Aspect 13. An apparatus for localization, comprising: a memory comprising instructions; and a processor coupled to the memory and configured to: obtain, from a vehicle, pose information for the vehicle; obtain a non-semantic layer of a map of an environment, the non-semantic layer including a map point corresponding to a target in the environment, wherein the map point is a non-semantic point, and wherein the map point includes heading information; determine, based on a comparison between the pose information and the heading information, that the target is relevant to the vehicle; and transmit the map point to the vehicle.
Aspect 14. The apparatus of Aspect 13, wherein the heading information is quantized into a predetermined number of directional ranges.
Aspect 15. The apparatus of any one of Aspects 13 to 14, the heading information indicates a heading in which the target is observable.
Aspect 16. The apparatus of any one of Aspects 13 to 15, wherein the map point includes an indication of a road in which the target is observable, and wherein the processor is configured to: obtain an indication of a road on which the vehicle is located; and determine that the target is relevant to the vehicle further based on a comparison between the indication of the road in which the target is observable and the indication of the road on which the vehicle is located.
Aspect 17. The apparatus of Aspect 16, wherein the map point includes an indication of a lane on the road in which target is observable, and wherein the processor is configured to: obtain an indication of the lane on the road in which the vehicle is located; and determine that the target is relevant to the vehicle further based on a comparison between the indication of a lane on the road in which target is observable and the lane on the road in which the vehicle is located in.
Aspect 18. The apparatus of any one of Aspects 16 or 17, wherein, to obtain the indication of the road on which the vehicle is located, the processor is configured to determine the road on which the vehicle is located based on the pose information.
Aspect 19. The apparatus of any one of Aspects 13 to 18, wherein the processor is further configured to: receive a generated map point from the vehicle; determine a threshold amount of time has passed since receiving the generated map point; and add the generated map point to the map of the environment.
Aspect 20. A method for localization, comprising: obtaining a point corresponding to a target in an environment, the point indicating a location of the target in the environment, and wherein the point is a non-semantic point for use with a non-semantic layer of a map; obtaining pose information indicating a heading of a vehicle; generating a map point based on a quantization of the obtained point; and outputting the generated map point to a map server.
Aspect 21. The method of Aspect 20, wherein the map point includes the location of the target and the pose information.
Aspect 22. The method of any one of Aspects 20 to 21, wherein the map server comprises a remote server.
Aspect 23. The method of any one of Aspects 20 to 22, wherein the heading information is quantized into a predetermined number of directional ranges.
Aspect 24. The method of any one of Aspects 20 to 23, further comprising obtaining an indication of a road on which the vehicle is located, and wherein the map point includes the indication of the road on which the vehicle is located.
Aspect 25. The method of Aspect 24, further comprising obtaining an indication of a lane of the road on which the vehicle is located, and wherein the map point includes the indication of the lane of the road on which the vehicle is located.
Aspect 26. The method of any one of Aspects 20 to 25, further comprising: determining a bin of a sensor space where the point is located, wherein the bin is a portion of the sensor space; determining a bin location within the bin where the point is located; and encoding the location of the target in the map point based on the determined bin and determined bin location.
Aspect 27. The method of any one of Aspects 20 to 26, further comprising outputting the generated map point based on a location of the vehicle.
Aspect 28. The method of Aspect 27, wherein outputting the generated map point comprises: determining that the vehicle is not within a threshold amount of time of a beginning or end of a trip; and outputting the generated map point based on the determination that the vehicle is not within the threshold amount of time of the beginning or the end of the trip.
Aspect 29. The method of Aspect 27, wherein the vehicle is associated with a trace identifier, and wherein the method further comprises: determining that the vehicle is not within a threshold amount of time of a beginning or end of a trip; and outputting the trace identifier along with the generated map point based on the determination that the vehicle is not within the threshold amount of time of the beginning or the end of the trip.
Aspect 30. The method of Aspect 27, wherein outputting the generated map point comprises: determining that the vehicle is not within a threshold distance of a beginning or end of a trip; and outputting the generated map point based on the determination that the vehicle is not within the threshold distance of the beginning or the end of the trip.
Aspect 31. The method of any one of Aspects 20 to 30, further comprising outputting the generated map point based on a speed of the vehicle.
Aspect 32. A method for localization, comprising: obtaining, from a vehicle, pose information for the vehicle; obtaining a non-semantic layer of a map of an environment, the non-semantic layer including a map point corresponding to a target in the environment, wherein the map point is a non-semantic point, and wherein the map point includes heading information; determining, based on a comparison between the pose information and the heading information, that the target is relevant to the vehicle; and transmitting the map point to the vehicle.
Aspect 33. The method of Aspect 32, wherein the heading information is quantized into a predetermined number of directional ranges.
Aspect 34. The method of any one of Aspects 32 to 33, the heading information indicates a heading in which the target is observable.
Aspect 35. The method of any one of Aspects 32 to 34, wherein the map point includes an indication of a road in which the target is observable, and wherein the method further comprises: obtaining an indication of a road on which the vehicle is located; and determining that the target is relevant to the vehicle further based on a comparison between the indication of the road in which the target is observable and the indication of the road on which the vehicle is located.
Aspect 36. The method of Aspect 35, wherein the map point includes an indication of a lane on the road in which target is observable, and wherein the method further comprises: obtaining an indication of the lane on the road in which the vehicle is located; and determining that the target is relevant to the vehicle further based on a comparison between the indication of a lane on the road in which target is observable and the lane on the road in which the vehicle is located in.
Aspect 37. The method of any one of Aspects 35 or 36, wherein, to obtain the indication of the road on which the vehicle is located, and wherein the method further comprises determining the road on which the vehicle is located based on the pose information.
Aspect 38. The method of any one of Aspects 32 to 37, further comprising: receiving a generated map point from the vehicle; determining a threshold amount of time has passed since receiving the generated map point; and adding the generated map point to the map of the environment.
Aspect 39. A non-transitory computer-readable medium having stored thereon instructions that, when executed by at least one processor, cause the at least one processor to: obtain a point corresponding to a target in an environment, the point indicating a location of the target in the environment, and wherein the point is a non-semantic point for use with a non-semantic layer of a map; obtain pose information indicating a heading of the apparatus; generate a map point based on a quantization of the obtained point; and output the generated map point to a map server.
Aspect 40. The non-transitory computer-readable medium of Aspect 39, having stored thereon instructions that, when executed by at least one processor, cause the at least one processor to perform one or more operations according to any of Aspects 21 to 31.
Aspect 41. A non-transitory computer-readable medium having stored thereon instructions that, when executed by at least one processor, cause the at least one processor to: obtain, from a vehicle, pose information for the vehicle; obtain a non-semantic layer of a map of an environment, the non-semantic layer including a map point corresponding to a target in the environment, wherein the map point is a non-semantic point, and wherein the map point includes heading information; determine, based on a comparison between the pose information and the heading information, that the target is relevant to the vehicle; and transmit the map point to the vehicle.
Aspect 42. The non-transitory computer-readable medium of Aspect 41, having stored thereon instructions that, when executed by at least one processor, cause the at least one processor to perform one or more operations according to any of Aspects 33 to 38 and 46.
Aspect 43. An apparatus for localization, comprising one or more means for performing operations according to any of Aspects 20 to 31.
Aspect 44. An apparatus for localization, comprising one or more means for performing operations according to any of Aspects 32 to 38 and 46.
Aspect 45. The apparatus of any of Aspects 13 to 19, wherein the map point includes quantized heading information.
Aspect 46. The method of any of Aspects 32 to 38, wherein the map point includes quantized heading information.
Aspect 47. A non-transitory computer-readable medium having stored thereon instructions that, when executed by at least one processor, cause the at least one processor to: obtain a point corresponding to a target in an environment, the point indicating a location of the target in the environment, and wherein the point is a non-semantic point for use with a non-semantic layer of a map; obtain pose information indicating a heading of a vehicle; generate a map point based on a quantization of the obtained point; and output the generated map point to a map server.
Aspect 48. The non-transitory computer-readable medium of Aspect 47, wherein the map point includes the location of the target and the pose information.
Aspect 49. The non-transitory computer-readable medium of any one of Aspects 47 to 48, wherein the map server comprises a remote server.
Aspect 50. The non-transitory computer-readable medium of any one of Aspects 47 to 49, wherein heading information indicated in the pose information is quantized into a predetermined number of direction ranges.
Aspect 51. The non-transitory computer-readable medium of any one of Aspects 47 to 50, wherein the instructions further cause the at least one processor to obtain an indication of a road on which the vehicle is located, and wherein the map point includes the indication of the road on which the vehicle is located.
Aspect 52. The non-transitory computer-readable medium of Aspect 51, wherein the instructions further cause the at least one processor to obtain an indication of a lane of the road on which the vehicle is located, and wherein the map point includes the indication of the lane of the road on which the vehicle is located.
Aspect 53. The non-transitory computer-readable medium of any one of Aspects 47 to 52, wherein the instructions further cause the at least one processor to: determine a bin of a sensor space where the point is located, wherein the bin is a portion of the sensor space; determine a bin location within the bin where the point is located; and encode the location of the target in the map point based on the determined bin and determined bin location.
Aspect 54. The non-transitory computer-readable medium of any one of Aspects 47 to 53, wherein the instructions further cause the at least one processor to output the generated map point based on a location of the vehicle.
Aspect 55. The non-transitory computer-readable medium of Aspect 54, wherein, to output the generated map point, the instructions further cause the at least one processor to: determine that the vehicle is not within a threshold amount of time of a beginning or end of a trip; and output the generated map point based on the determination that the vehicle is not within the threshold amount of time of the beginning or the end of the trip.
Aspect 56. The non-transitory computer-readable medium of any one of Aspects 54 to 55, wherein the vehicle is associated with a trace identifier, and wherein the instructions further cause the at least one processor to: determine that the vehicle is not within a threshold amount of time of a beginning or end of a trip; and output the trace identifier along with the generated map point based on the determination that the vehicle is not within the threshold amount of time of the beginning or the end of the trip.
Aspect 56. The non-transitory computer-readable medium of any one of Aspects 54 to 56, wherein, to output the generated map point, the instructions further cause the at least one processor to: determine that the vehicle is not within a threshold distance of a beginning or end of a trip; and output the generated map point based on the determination that the vehicle is not within the threshold distance of the beginning or the end of the trip.
Aspect 57. The non-transitory computer-readable medium of any one of Aspects 47 to 56, wherein the instructions further cause the at least one processor to output the generated map point based on a speed of the vehicle.
Aspect 58. The apparatus of Aspect 4, wherein the predetermined number of direction ranges comprises four directional quadrants.
Aspect 59. The apparatus of Aspect 14, wherein the predetermined number of direction ranges comprises four directional quadrants.
Aspect 60. The method of Aspect 23, wherein the predetermined number of direction ranges comprises four directional quadrants.
Aspect 61. The method of Aspect 33, wherein the predetermined number of direction ranges comprises four directional quadrants.
Aspect 61. The non-transitory computer-readable medium of Aspect 50, wherein the predetermined number of direction ranges comprises four directional quadrants.

What is claimed is:

1. An apparatus for localization, comprising:
at least one memory comprising instructions; and
at least one processor coupled to the at least one memory and configured to:
obtain a point corresponding to a target in an environment, the point indicating a location of the target in the environment, and wherein the point is a non-semantic point for use with a non-semantic layer of a map;
obtain pose information indicating a heading of the apparatus;
generate a map point based on a quantization of the obtained point; and
output the generated map point to a map server.

2. The apparatus of claim 1, wherein the map point includes the location of the target and the pose information.

3. The apparatus of claim 1, wherein the map server comprises a remote server.

4. The apparatus of claim 1, wherein heading information indicated in the pose information is quantized into a predetermined number of directional ranges.

5. The apparatus of claim 4, wherein the predetermined number of direction ranges comprises four directional quadrants.

6. The apparatus of claim 1, wherein the at least one processor is further configured to obtain an indication of a road on which the apparatus is located, and wherein the map point includes the indication of the road on which the apparatus is located.

7. The apparatus of claim 6, wherein the at least one processor is further configured to obtain an indication of a lane of the road on which the apparatus is located, and wherein the map point includes the indication of the lane of the road on which the apparatus is located.

8. The apparatus of claim 1, wherein the at least one processor is further configured to:
determine a bin of a sensor space where the point is located, wherein the bin is a portion of the sensor space;
determine a bin location within the bin where the point is located; and
encode the location of the target in the map point based on the determined bin and determined bin location.

9. The apparatus of claim 1, wherein the at least one processor is further configured to output the generated map point based on a location of the apparatus.

10. The apparatus of claim 9, wherein, to output the generated map point, the at least one processor is configured to:
determine that the apparatus is not within a threshold amount of time of a beginning or end of a trip; and
output the generated map point based on the determination that the apparatus is not within the threshold amount of time of the beginning or the end of the trip.

11. The apparatus of claim 9, wherein the apparatus is associated with a trace identifier, and wherein the at least one processor is further configured to:
determine that the apparatus is not within a threshold amount of time of a beginning or end of a trip; and
output the trace identifier along with the generated map point based on the determination that the apparatus is not within the threshold amount of time of the beginning or the end of the trip.

12. The apparatus of claim 9, wherein, to output the generated map point, the at least one processor is configured to:
determine that the apparatus is not within a threshold distance of a beginning or end of a trip; and
output the generated map point based on the determination that the apparatus is not within the threshold distance of the beginning or the end of the trip.

13. The apparatus of claim 1, wherein the at least one processor is further configured to output the generated map point based on a speed of the apparatus.

14. A method for localization, comprising:
obtaining a point corresponding to a target in an environment, the point indicating a location of the target in the environment, and wherein the point is a non-semantic point for use with a non-semantic layer of a map;
obtaining pose information indicating a heading of a vehicle;
generating a map point based on a quantization of the obtained point; and
outputting the generated map point to a map server.

15. The method of claim 14, wherein the map point includes the location of the target and the pose information.

16. The method of claim 14, wherein the map server comprises a remote server.

17. The method of claim 14, wherein the indicated heading is quantized into a predetermined number of directional ranges.

18. The method of claim 17, wherein the predetermined number of direction ranges comprises four directional quadrants.

19. The method of claim 14, further comprising obtaining an indication of a road on which the vehicle is located, and wherein the map point includes the indication of the road on which the vehicle is located.

20. The method of claim 19, further comprising obtaining an indication of a lane of the road on which the vehicle is located, and wherein the map point includes the indication of the lane of the road on which the vehicle is located.

21. The method of claim 14, further comprising:
determining a bin of a sensor space where the point is located, wherein the bin is a portion of the sensor space;
determining a bin location within the bin where the point is located; and
encoding the location of the target in the map point based on the determined bin and determined bin location.

22. The method of claim 14, further comprising outputting the generated map point based on a location of the vehicle.

23. The method of claim 22, wherein outputting the generated map point comprises:
determining that the vehicle is not within a threshold amount of time of a beginning or end of a trip; and
outputting the generated map point based on the determination that the vehicle is not within the threshold amount of time of the beginning or the end of the trip.

24. The method of claim 22, wherein the vehicle is associated with a trace identifier, and wherein the method further comprises:
determining that the vehicle is not within a threshold amount of time of a beginning or end of a trip; and
outputting the trace identifier along with the generated map point based on the determination that the vehicle is not within the threshold amount of time of the beginning or the end of the trip.

25. The method of claim 22, wherein outputting the generated map point comprises:
determining that the vehicle is not within a threshold distance of a beginning or end of a trip; and
outputting the generated map point based on the determination that the vehicle is not within the threshold distance of the beginning or the end of the trip.

26. The method of claim 14, further comprising outputting the generated map point based on a speed of the vehicle.

27. A non-transitory computer-readable medium having stored thereon instructions that, when executed by at least one processor, cause the at least one processor to:
obtain a point corresponding to a target in an environment, the point indicating a location of the target in the environment, and wherein the point is a non-semantic point for use with a non-semantic layer of a map;
obtain pose information indicating a heading of a vehicle;
generate a map point based on a quantization of the obtained point; and
output the generated map point to a map server.

28. The non-transitory computer-readable medium of claim 27, wherein the map point includes the location of the target and the pose information.

29. The non-transitory computer-readable medium of claim 27, wherein heading information indicated in the pose information is quantized into a predetermined number of directional ranges.

30. An apparatus comprising:
means for obtaining a point corresponding to a target in an environment, the point indicating a location of the target in the environment, and wherein the point is a non-semantic point for use with a non-semantic layer of a map;
means for obtaining pose information indicating a heading of a vehicle;
means for generating a map point based on a quantization of the obtained point; and
means for outputting the generated map point to a map server.
